(19) United States
(12) Patent Application Publication
(10) Pub. No.: US 2026/0110874 A1
(43) Pub. Date: Apr. 23, 2026

(54) BALL BEARING MOTOR

(71) Applicant: Luxshare Intelligent Manufacture Technology (Changshu) Co., Ltd, Changshu City (CN)

(72) Inventors: Chia-Ching HSU, Changshu City (CN); Yuan-Ching LEE, Changshu City (CN)

(73) Assignee: Luxshare Intelligent Manufacture Technology (Changshu) Co., Ltd, Changshu City (CN)

(21) Appl. No.: 19/012,336

(22) Filed: Jan. 7, 2025

(30) Foreign Application Priority Data
Oct. 22, 2024 (CN) 202411480127.8

(51) Int. Cl. F16C 29/00; F16C 29/04; G02B 7/04; H02K 7/08

(52) U.S. Cl. CPC F16C 29/002; F16C 29/04; G02B 7/04; F16C 2370/20; F16C 2380/26; H02K 7/08

(57) ABSTRACT

Provided is a ball bearing motor, relating to the technical field of camera module lens driving devices. The ball bearing motor includes a movable portion, a fixed portion, a driving portion, and balls. Under the action of the driving portion, the movable portion is movable relative to the fixed portion. A first ball track groove body and a second ball track groove body are provided on the fixed portion and the movable portion, respectively. The balls are sandwiched between the first ball track groove body and the second ball track groove body and can roll in the first ball track groove body and the second ball track groove body when the movable portion moves relative to the fixed portion. At least one of the first ball track groove body and the second ball track groove body can provide buffering for the balls through elastic deformation.

### CROSS-REFERENCE TO RELATED APPLICATION

This application claims priority to Chinese Patent Application No. 202411480127.8 filed Oct. 22, 2024, the disclosure of which is incorporated herein by reference in its entirety.

### TECHNICAL FIELD

The present disclosure relates to the technical field of camera module lens driving devices and, in particular, to a ball bearing motor.

### BACKGROUND

During the imaging process of a camera module, to better improve the imaging quality of the camera module, a corresponding driving device may be provided in the camera module structure to drive an optical lens to move along the optical axis direction so that a clearer image can be obtained. In the related art, the driving device generally selected is a motor structure, such as a ball bearing motor structure, a shape memory alloy (SMA) motor structure, or a piezoelectric motor structure.

The ball bearing motor needs to be provided with a track groove so that the balls can move along the direction limited by the track groove. However, the structure of the track groove is generally a plastic part, which has relatively poor hardness compared with the balls. After reliability tests (including physical tests such as falling), the track groove is prone to permanent deformation due to stress damage, affecting the movement trajectory of the balls.

### SUMMARY

An object of the present disclosure is to provide a ball bearing motor, thereby effectively avoiding the plastic deformation of a track structure and ensuring the reliability of a ball movement trajectory.

To achieve the object, the present disclosure adopts the technical solutions below.

A ball bearing motor includes a fixed portion, a movable portion, and balls. The fixed portion is provided with a first ball track groove body. The movable portion is provided with a second ball track groove body. The balls are sandwiched between the first ball track groove body and the second ball track groove body. The movable portion is driven by a driving portion to be movable relative to the fixed portion. When the movable portion moves relative to the fixed portion, the balls roll in the first ball track groove body and the second ball track groove body. At least one of the first ball track groove body and the second ball track groove body can provide buffering for the balls through elastic deformation.

In an embodiment, a cavity is provided in the first ball track groove body.

In an embodiment, the cavity is configured in a honeycomb shape.

In an embodiment, the cavity is filled with an elastomer.

In an embodiment, the wall of the cavity is configured to be a zigzag structure.

In an embodiment, the elastomer is moulded and then filled into the cavity, and the cavity penetrates the fixed portion along the movement direction of the movable portion through two opposite sides of the fixed portion.

In an embodiment, the cavity has an opening connecting with the outer side, and the elastomer is formed by solidifying the liquid in the cavity.

In an embodiment, the first ball track groove body includes a body portion and a track portion, the track portion is connected to the body portion through an elastic member, and the balls are sandwiched between the track portion and the second ball track groove body.

In an embodiment, the elastic member includes an elastic piece, a mounting groove is provided on a side of the body portion facing the first ball track groove body, and the elastic piece is located in the mounting groove and spaced apart from the bottom of the mounting groove.

In an embodiment, the elastic piece and the track portion are fixed through insertion.

The present disclosure has the beneficial effects below.

The balls in the ball bearing motor proposed in the embodiments of the present disclosure are movable along the optical axis direction of the lens under the restriction of the first ball track groove body and the second ball track groove body. When the ball bearing motor is impacted by an external force, at least one of the first ball track groove body and the second ball track groove body can provide a buffering elastic force to the balls, thereby reducing the possibility of plastic deformation such as pits being formed in the first ball track groove body and the second ball track groove body and improving the accuracy and reliability of the movement direction of the balls.

### BRIEF DESCRIPTION OF DRAWINGS

FIG. 1 is a schematic view illustrating the structure of a ball bearing motor according to an embodiment of the present disclosure.

FIG. 2 is a view illustrating the positional relationship between a movable portion and a fixed portion according to an embodiment of the present disclosure.

FIG. 3 is a sectional view of a ball bearing motor according to an embodiment of the present disclosure.

FIG. 4 is a sectional view of a ball bearing motor according to another embodiment of the present disclosure.

FIG. 5 is a sectional view of a first ball track groove body in the embodiment of FIG. 4.

FIG. 6 is a sectional view of a ball bearing motor according to another embodiment of the present disclosure.

FIG. 7 is a sectional view of a first ball track groove body in the embodiment of FIG. 6.

FIG. 8 is a schematic view illustrating the structure of an elastic piece.

### REFERENCE LIST

1 fixed portion
11 first ball track groove body
111 cavity
112 elastomer
113 elastic piece
1131 insertion hole
1132 strip-like notch
114 first ball track groove
115 body portion
1151 mounting groove
1152 limiting groove
116 track portion
1161 insert block
2 movable portion
21 second ball track groove body
211 second ball track groove
3 ball
4 housing

### DETAILED DESCRIPTION

The present disclosure is further described below in detail in conjunction with drawings and embodiments. It is to be understood that the embodiments described herein are intended to illustrate and not to limit the present disclosure. Additionally, it is to be noted that for ease of description, only part, not all, of structures related to the present disclosure are illustrated in the drawings.

In the description of the present disclosure, terms “joined”, “connected”, and “fixed” are to be understood in a broad sense unless otherwise expressly specified and limited. For example, the term “connected” may refer to “fixedly connected”, “detachably connected”, or “integrated”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present disclosure may be understood based on specific situations.

In the present disclosure, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as “upper”, “lower”, and “right” are based on the drawings. These orientations or position relations are intended only to facilitate description and simplify operations and not to indicate or imply that a device or element referred to must have such particular orientations or must be configured or operated in such particular orientations. Thus, these orientations or position relations are not to be construed as limiting the present disclosure. In addition, the terms “first” and “second” are only used for distinguishing between descriptions and have no special meanings.

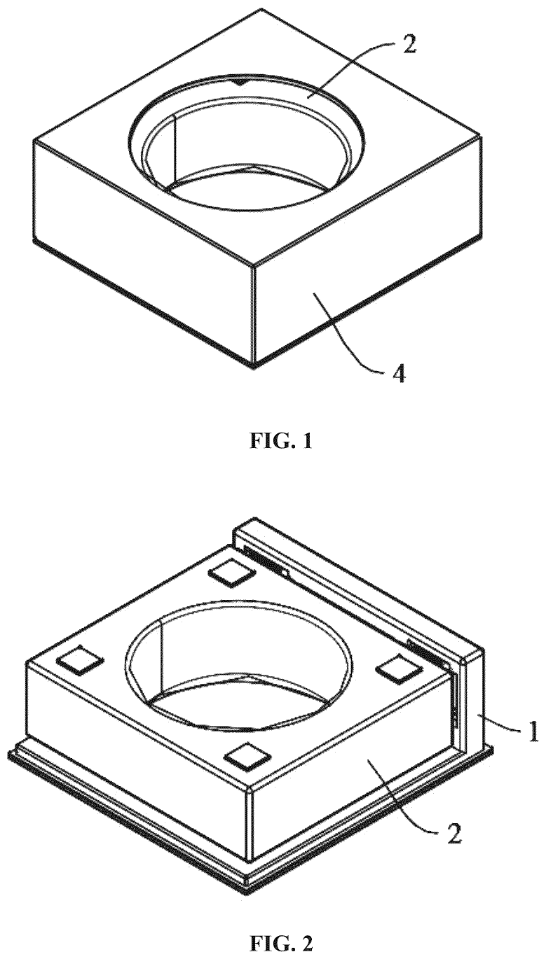

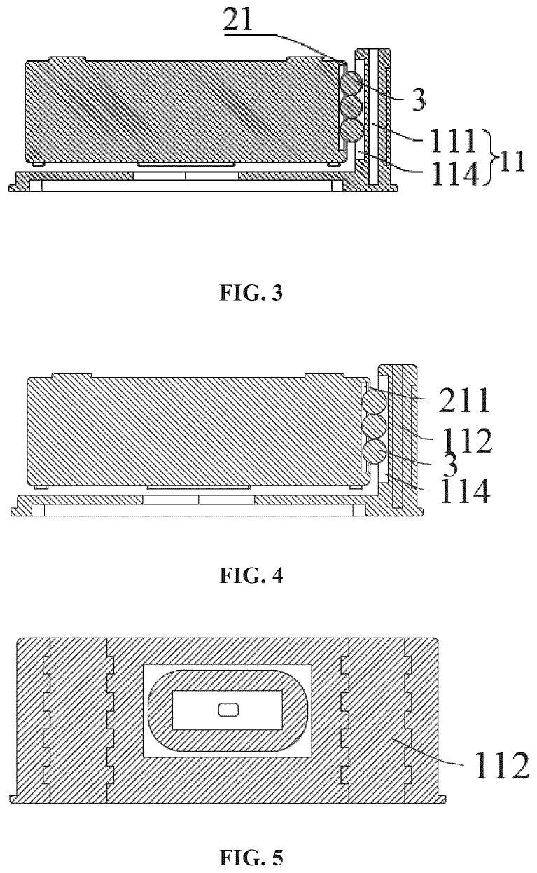

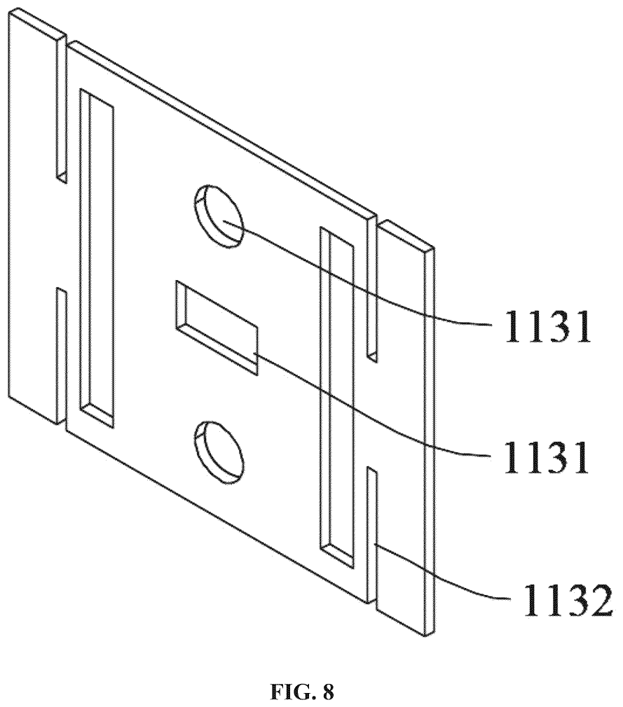

Referring to FIGS. 1 to 8, a ball bearing motor includes a housing 4, a movable portion 2, a fixed portion 1, a driving portion, and balls 3. The driving portion includes a magnet and a coil. The magnet is disposed on the moving portion 2, and the coil is disposed on the fixed portion 1. After the coil is energized, the movable portion 2 may drive the lens located on the movable portion 2 to move relative to the fixed portion 1 along the optical axis direction of the lens so that a clearer image can be obtained. The balls 3 are disposed between the movable portion 2 and the fixed portion 1 to reduce the friction when the movable portion 2 moves relative to the fixed portion 1. The housing 4 covers the movable portion 2, the fixed portion 1, the driving portion, the balls 3, and other elements to protect the preceding elements.

To limit the movement path of the balls 3 so that the balls 3 move along the optical axis direction of the lens, a first ball track groove body 11 and a second ball track groove body 21 are provided on the fixed portion 1 and the movable portion 2, respectively. A first ball track groove 114 and a second ball track groove 211 with opposite notches are provided on the first ball track groove body 11 and the second ball track groove body 21, respectively. The balls 3 are sandwiched between the first ball track groove body 11 and the second ball track groove body 21. When the movable portion 2 moves relative to the fixed portion 1, the balls 3 roll in the first ball track groove 114 of the first ball track groove body 11 and the second ball track groove 211 of the second ball track groove body 21 so that the movable portion 2 can move relative to the fixed portion 1 along the optical axis direction of the lens. It is to be emphasized here that at least one of the first ball track groove body 11 and the second ball track groove body 21 can provide buffering for the balls 3 through elastic deformation so that the possibility of pits being generated in the first ball track groove body 11 and the movement accuracy of the balls 3 being reduced when the ball bearing motor is impacted by an external force can be reduced.

In an embodiment, a cavity 111 is provided in the first ball track groove body 11. The cavity 111 is located on a side of the first ball track groove 114 facing away from the second ball track groove body 21 and is aligned with the first ball track groove 114. The cavity 111 is provided so that the first ball track groove body 11 can provide an elastic force to the balls 3. It is to be understood that the cavity 111 may be either closed or have an opening that penetrates the surface of the fixed portion 1 to connect with the outer side.

To provide better buffering, the size of the cavity 111 is designed according to the dimension of the first ball track groove 114 so that the orthographic projection of the first ball track groove 114 on the cavity 111 completely falls within the region where the cavity 111 is located. In this manner, the cavity 111 can cover the entire first ball track groove 114.

It is to be understood that the cavity 111 may be a completely hollow structure or a honeycomb structure that is formed by multiple hollow structures arranged at intervals, thereby providing the best buffering effect.

In an embodiment, the cavity 111 is filled with an elastomer 112 with a good buffering capability. The elastomer 112 can further absorb an external impact on the first ball track groove body 11, reduce stress concentration, avoid the plastic deformation of the first ball track groove body 11, and thus avoid possible pitting.

Specifically, to provide a better buffering capability, the elastomer 112 completely fits the wall of the cavity 111. It is to be understood that the elastomer 112 may be moulded and then filled into the cavity 111 or may be filled into the cavity 111 and then moulded.

For example, the elastomer 112 is moulded and then filled into the cavity 111. In this case, the elastomer 112 may be made of silicone material, which has high resilience and durability, high-temperature resistance, and aging resistance. The elastomer 112 may also be made of thermoplastic polyurethane (TPU), which has good wear resistance and elasticity and low-temperature resistance. The elastomer 112 may also be made of rubber, which has excellent elasticity and wear resistance and is suitable for use in various environments.

Referring to FIG. 5, to enable the elastomer 112 to provide a more uniform buffering capability, the cavity 111 penetrates two surfaces of the fixed portion 1 that are opposite to each other along the optical axis direction, that is, along the movement direction of the movable portion 2.

Optionally, the wall of the cavity 111 is configured to be a zigzag structure, and correspondingly, the edges of the elastomer 112 are also configured to be zigzag shapes to engage with the wall of the cavity 111, thereby enhancing the connection stability between the elastomer 112 and the fixing portion 1 and preventing the elastomer 112 from sliding.

Of course, the elastomer 112 may be filled at the position where the cavity 111 is disposed in the fixed portion 1 when the fixed portion 1 is injection-moulded, or the elastomer 112 may be filled into the cavity 111 after the fixed portion 1 is moulded.

Alternatively, the elastomer 112 is formed by solidifying the liquid filled into the cavity 111 or the liquid coated on the groove wall of the cavity 111. For example, the elastomer 112 is a glue layer formed by solidifying silicone glue/polyurethane (PU) glue/acrylic glue/epoxy resin glue. The preceding glue is filled into the cavity 111 to form the elastomer 112. At this time, the cavity 111 has an opening connecting with the outer side.

The silicone glue is featured with strong adhesion, high-temperature resistance, and good elasticity. The PU glue is featured with strong adhesion, wear resistance, and good elasticity. The acrylic glue is featured with strong adhesion and fast solidification speed but relatively poor elasticity. For specific use, selection is made according to requirements.

In another embodiment, the first ball track groove body 11 is split and includes a body portion 115 and a track portion 116. The body portion 115 is used for supporting the track portion 116. The track portion 116 is located on a side of the body portion 115 facing the movable portion 2. The first ball track groove 114 is formed on the track portion 116. The track portion 116 is movably connected to the body portion 115 through an elastic member. The elastic member can provide a buffering elastic force to the track portion 116 to reduce stress concentration.

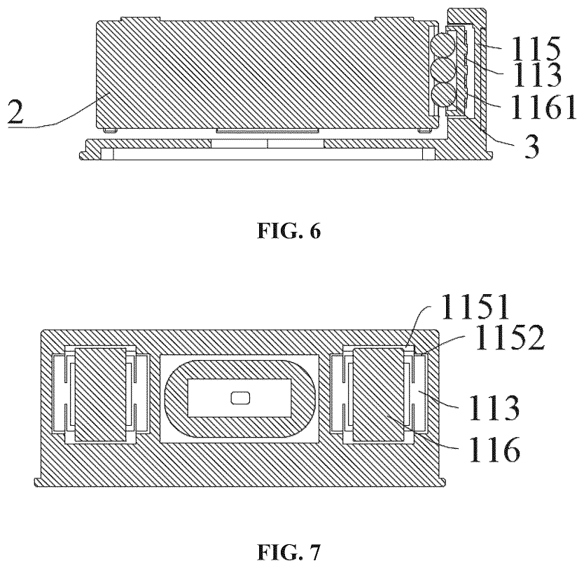

The elastic member may be an elastic piece 113 such as a metal elastic piece or a plastic elastic piece or may be a spring. The case where the elastic member is the elastic piece 113 is used as an example. Apparently, a deformation space exists between the elastic piece 113 and the body portion 115. Referring to FIGS. 5 and 6, a mounting groove 1151 is provided on a side of the body portion 115 facing the track portion 116, the elastic piece 113 is fixed in the mounting groove 1151 and spaced apart from the bottom of the mounting groove 1151, and the track portion 116 is fixed on a side of the elastic piece 113 facing away from the bottom of the mounting groove 1151.

Specifically, to reduce the difficulty of mounting the elastic piece 113 in the mounting groove 1151, the mounting groove 1151 is provided with a limiting groove 1152 on each of the two opposite sides of the mounting groove 1151, the limiting grooves 1152 connect with the mounting groove 1151, the groove direction of the limiting groove 1152 is consistent with the groove direction of the mounting groove 1151, the groove depth of the limiting groove 1152 is less than the groove depth of the mounting groove 1151, and the two opposite ends of the elastic piece 113 are mounted in the limiting groove 1152. More specifically, to increase the elastic force of the elastic piece 113, strip-like notch groups are provided on two opposite sides of the elastic piece 113 in a direction perpendicular to the movement direction of the movable portion 2, each strip-like notch group includes two strip-like notches 1132 symmetrically arranged along the movement direction of the movable portion 2, and the strip-like notches 1132 extend from an edge of the elastic piece 113 to the other edge along the movement direction of the movable portion 2.

In addition, to reduce the difficulty of connecting the track portion 116 to the elastic piece 113, the insertion hole 1131 are provided on the elastic piece 113, and correspondingly, the insert block 1161 is provided on the track portion 116. The track portion 116 and the elastic piece 113 are fixedly connected by the insertion hole 1131 and the insert block 1161 that mate with each other through insertion. It is to be understood that the insertion hole 1131 may be configured to be square, circular, or any other shape, which is not specifically limited herein. Of course, the insertion hole 1131 may be provided on the track portion 116 and the insert blocks may be provided on the elastic piece 113 so that the track portion 116 and the elastic piece 113 mate with each other through insertion.

In other embodiments, the movable portion 2 provided with the second ball track groove body 21 may be designed according to the principle and structure of the fixed portion 1 provided with the first ball track groove body 11 in which buffering and elasticity are ensured. The details are not repeated here.

Apparently, the preceding embodiments of the present disclosure are illustrative of the present disclosure and are not intended to limit embodiments of the present disclosure. Those of ordinary skill in the art can make various apparent modifications, adaptations, and substitutions without departing from the scope of the present disclosure. All embodiments do not need to be and cannot be exhausted herein. Any modifications, equivalent substitutions, and improvements made within the spirit and principle of the present disclosure fall within the scope of the claims of the present disclosure.

What is claimed is:

1. A ball bearing motor, comprising:
a fixed portion provided with a first ball track groove body;
a movable portion provided with a second ball track groove body; and
balls sandwiched between the first ball track groove body and the second ball track groove body, wherein the movable portion is driven by a driving portion to be movable relative to the fixed portion; when the movable portion moves relative to the fixed portion, the balls roll in the first ball track groove body and the second ball track groove body; and at least one of the first ball track groove body and the second ball track groove body is capable of providing buffering for the balls through elastic deformation.

2. The ball bearing motor of claim 1, wherein a cavity is provided in the first ball track groove body.

3. The ball bearing motor of claim 2, wherein the cavity is configured in a honeycomb shape.

4. The ball bearing motor of claim 2, wherein the cavity is filled with an elastomer.

5. The ball bearing motor of claim 4, wherein a wall of the cavity is configured to be a zigzag structure.

6. The ball bearing motor of claim 4, wherein the elastomer is moulded and then filled into the cavity, and the cavity penetrates the fixed portion along a movement direction of the movable portion through two opposite sides of the the movable portion.

7. The ball bearing motor of claim 4, wherein the cavity has an opening connecting with an outer side, and the elastomer is formed by solidifying liquid in the cavity.

8. The ball bearing motor of claim 1, wherein the first ball track groove body comprises a body portion and a track portion, the track portion is connected to the body portion through an elastic member, and the balls are sandwiched between the track portion and the second ball track groove body.

9. The ball bearing motor of claim 8, wherein the elastic member comprises an elastic piece, a mounting groove is provided on a side of the body portion facing the first ball track groove body, and the elastic piece is located in the mounting groove and spaced apart from a bottom of the mounting groove.

10. The ball bearing motor of claim 9, wherein the elastic piece and the track portion are fixed through insertion.
